(19) United States
(12) Patent Application Publication
(10) Pub. No.: US 2025/0148357 A1
(43) Pub. Date: May 8, 2025

(54) FLEXIBLE MACHINE LEARNING MODEL COMPRESSION

(71) Applicant: Google LLC, Mountain View, CA (US)

(72) Inventors: Aditya Binodkumar Agrawal, Santa Clara, CA (US); Blake Alan Hechtman, Mountain View, CA (US); Matthew Leever Hedlund, Sun Prairie, WI (US); David Alexander Majnemer, Mountain View, CA (US); Marissa Karen Ikonomidis, Sunnyvale, CA (US)

(21) Appl. No.: 18/504,016

(22) Filed: Nov. 7, 2023

(51) Int. Cl. G06N 20/00

(52) U.S. Cl. CPC G06N 20/00

(57) ABSTRACT

Methods, systems, and apparatus, including computer programs encoded on a computer storage medium, for compresses a machine learning model having a plurality of parameters. In one aspect, one of the methods includes obtaining trained values of a set of parameters for at least a portion of a machine learning model; identifying one or more dense ranges for the trained values; determining a least number of bits required to represent each trained value within the one or more dense ranges; identifying a second format having a range that is smaller than a range of the first format; and generating a compressed version of the at least a portion of the machine learning model.

### BACKGROUND

This specification relates to machine learning models.

Machine learning models receive an input and generate an output, e.g., a predicted output, based on the received input. Some machine learning models are parametric models and generate the output based on the received input and on values of the parameters of the model. A general trend with machine learning models is that they are becoming larger and more complicated. For example, large-scale neural networks, e.g., neural networks with millions, billions, or more parameters, are now being used to solve problems in natural language processing, image processing, computer vision, robotics, and health care. A large-scale neural network can have a very large memory footprint. As a consequence, mobile devices and embedded system with limited memory resources, such as laptops, tablets, and smartphones, may be incapable of storing a large-scale neural network.

One way of reducing model size and computational complexity is to apply post-training quantization techniques to constrain each parameter value down to a smaller number of possible values that could be represented in fewer bits after training. However, valuable information can be lost by existing quantization techniques, reducing the quality of the model.

### SUMMARY

This specification describes a machine learning model compression system (“compression system”) implemented as one or more computer programs on one or more computers in one or more locations, which compresses a machine learning model having a plurality of parameters. In particular, the compression system compresses a trained machine learning model so that the model will have a smaller memory footprint with no or minimal reduction in its prediction accuracy.

Particular embodiments of the subject matter described in this specification can be implemented so as to realize one or more of the following advantages. This specification describes techniques for machine learning model compression by identifying one or more dense ranges within a possible range of parameter values based on the distribution of the parameter values, and subsequently compressing a model by converting parameter values that fall within the dense ranges from an original format to a compact format that can be represented in fewer bits than the original format, while setting parameter values that fall outside the dense ranges to zero (or a another predefined value), which no longer need to be stored. The described techniques can generate compressed models with no or minor degradation in prediction accuracy in comparison to existing quantization techniques. The described techniques are flexible, and so can broadly apply to any portion of any machine learning model having any of a wide variety of architectures, including language model neural networks.

As one example technical effect and benefit, the described techniques enable compression of a large language model (LLM) to a compressed model that has a significantly reduced size relative to the LLM. This significantly smaller compressed model requires less memory usage to store. The smaller compressed model will also often be faster to run or, stated differently, exhibit less latency. Thus, some aspects of the present specification enable savings of computing resources such as memory usage, processor usage, network bandwidth, and the like. In particular, by reducing the size of the LLM, the LLM can more easily be deployed to perform on-device inference in a resource-constrained environment such as a mobile or edge device. By enabling on-device inference, latency experienced by the user can further be reduced as round trip communication to a higher order device, e.g., a cloud server, can be eliminated. Likewise, user privacy can be enhanced as prompt text can be processed on the device, without being transmitted to the cloud server.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example machine learning model compression system and an example inference system.

FIG. 2 shows a histogram showing an example distribution of values of a set of parameters of a trained machine learning model.

FIG. 3 is a flow diagram of an example process for compressing a machine learning model.

FIG. 4 is an example illustration of storing a compressed machine learning model.

Like reference numbers and designations in the various drawings indicate like elements.

### DETAILED DESCRIPTION

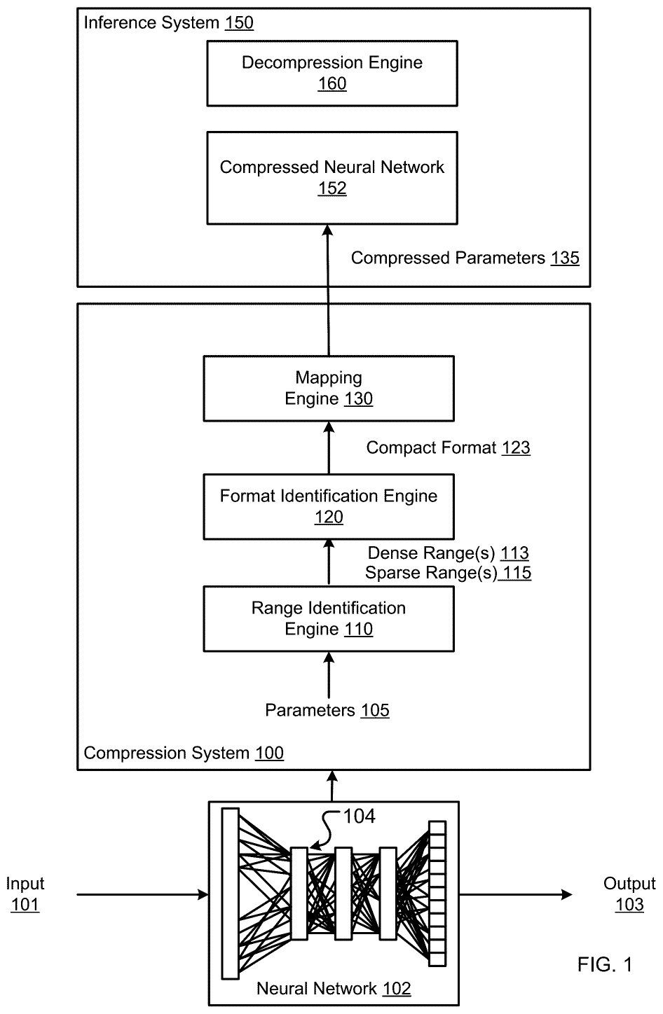

FIG. 1 shows an example machine learning model compression system (“compression system”) 100 and an example inference system 150. The compression system 100 and the inference system 150 are examples of systems that are each implemented as one or more computer programs on one or more computers in one or more locations, in which the systems, components, and techniques described below can be implemented. The compression system 100 compresses a machine learning model having a plurality of parameters for the inference system 150 to use.

In some cases, the machine learning model is a neural network, e.g., the neural network 102 of FIG. 1. The neural network 102 can be a feed-forward neural network (e.g., an attention neural network, a multi-layer perceptron, or a convolutional neural network), a recurrent neural network (e.g., a long short-term memory network), or any other kind of neural network.

As a particular example, the neural network 102 can be a language model neural network that has any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A.Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020. The contents of each of these documents is incorporated by reference into this specification in its entirety.

The neural network 102 can be configured to receive any kind of digital data input 101 and to perform any kind of prediction task (e.g., generative task, classification task, or regression task) on the input 101 to generate an output 103. A few examples follow.

In some cases, the neural network 102 is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network 102 is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task may be an audio processing task. For example, if the input to the neural network 102 is a sequence representing a spoken utterance, the output generated by the neural network may be a score for each of a set of pieces of text, each score representing an estimated likelihood that the piece of text is the correct transcript for the utterance. As another example, if the input to the neural network 102 is a sequence representing a spoken utterance, the output generated by the neural network can indicate whether a particular word or phrase (“hotword”) was spoken in the utterance. As another example, if the input to the neural network 102 is a sequence representing a spoken utterance, the output generated by the neural network 102 can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like. As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the neural network 102 can be configured to perform multiple individual natural language understanding tasks, with the input including an identifier for the individual natural language understanding task to be performed on the network input.

In some cases, the task is a multi-modal task that requires processing both text and image inputs, so that the neural network 102 includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

The example neural network applications described above are not exhaustive, and other applications for the neural networks may also be used.

In other cases, the machine learning model is a non-neural model. For example, the machine learning model can be one of: a decision tree model, a random forest model, a gradient boosting model, a linear regression model, a logistical regression model, a support vector machine (SVM) model, and so on. Depending on its actual, non-neural model configuration, the machine learning model can receive an input and perform the same or different tasks as discussed above on the input to generate an output.

For convenience, this specification largely describes techniques for compressing a neural network. It should be noted that, however, that the described techniques can also be applied to compress other types of machine learning models, including, for example, the non-neural models referenced above and other parametric machine learning models.

Typically, the neural network 102 is a trained neural network. A trained neural network means that the neural network has a set of parameters, with each parameter assigned a trained value in a given format that has been derived through a neural network training procedure operating on a training set of inputs.

Training a neural network results in trained values being determined for each parameter associated with each layer of the neural network. In the particular example of a Transformer-based neural network, trained values can be determined for the parameters associated with the embedding layer (that embeds an input into a numeric representation), the attention layers (that applies an attention mechanism on a layer input to generate a layer output), the output layer (that maps a layer output of the last attention layer to an output of the neural network), and other layers that might be included in the Transformer-based neural network.

At least a portion of the parameters of the neural network 102 are compressed before performing inference using an inference system (e.g., the inference system 150). This is because, generally, the inference system 150 uses a compressed neural network 152 to perform inference.

The compressed neural network 152 has the same architecture (e.g., type, number, and dimensionality of network layers) as the (non-compressed) neural network 102, the same number of parameters as the neural network 102, and is configured to perform the same prediction task as the neural network 102. However, while performing inference, the inference system 150 stores parameter values in one or more compact formats that are different than the given (initial) format that was used in the training of the neural network 102. Representing numbers, including the trained values of the parameters of the neural network 102, in a compact format will result in reduction in the size of the neural network 102, and, therefore, enable savings of computing resources such as memory usage, processor usage, network bandwidth, and the like.

The compression system 100 converts the trained values of the parameters (e.g., the set of parameters 105) of the neural network 102 represented in the given format to compressed values represented in one or more compact formats and provides data (e.g., the set of compressed parameters 135) specifying the compressed neural network 152 to the inference system 150. In particular, the compact format is a format that uses fewer number of bits to represent a value than the original, given format.

Once the trained neural network 102 is compressed, the inference system 150 uses the compressed neural network 152 having the compressed parameters 135 to perform inference. In some implementations, the inference system 150 receives new inputs (e.g., from users of the system), and processes those new inputs in accordance with uncompressed parameters, which have been generated by a decompression engine 160 from the compressed parameters 135, to generate new outputs.

A value occupies a certain number of bits in computer memory. Depending on the ranges of values used in computing, different number of bits may be allocated in the computer memory. In computing, and, in particular, in the field of artificial intelligence (AI) and machine learning (ML), values are often represented either in an integer format or a floating-point format. Table 1 shows a list of example integer formats that are commonly used in AI/ML.

TABLE 1

| Integer Format | Bit length |
|---|---|
| int8 | 8 |
| int16 | 16 |
| int32 | 32 |
| int64 | 64 |

### Example Integer Formats

The range of an integer format is −2⁽ⁿ⁻¹⁾ to 2⁽ⁿ⁻¹⁾−1 for signed integers, and 0 to 2ⁿ−1 for unsigned integers, where n is the bit length. For example, an integer represented in int8 format takes 8 bits, which has the maximum range of −128 to 127 if it is a signed integer (−2⁷ to 2⁷−1), and the range of 0 to 255 if it is an unsigned integer (0 to 2⁸−1).

A floating-point format uses formulaic representation of real numbers as an approximation to support a trade-off between range and precision. A value may be represented approximately to a fixed number of mantissa digits (note that the mantissa may also be referred to as “significand”) and scaled using an exponent in some fixed base (note that the exponent may also be referred to as a scale, or exponential scale), where the base for the scaling may be two, ten, or sixteen (or another integer). The value may be represented in the following form: mantissa×base^{exponent}, where the mantissa may be an integer or a floating-point value, base is an integer greater than or equal to two, and exponent is an integer. For example, a floating-point value represented in half-precision format takes 16 bits (5 for exponent, 10 for mantissa, and 1 for sign), which has the maximum range of ˜5.96 e⁻⁸ to 65504. Table 2 shows a list of example floating-point formats that are commonly used in AI/ML.

TABLE 2
Example Floating-point Formats

| Floating-point | | Exponent | Mantissa | Sign |
|---|---|---|---|---|
| Format | Shorthand | size | size | bit |
| half-precision | float16, fp16 | 5 | 10 | 1 |
| Brain | bfloat16 | 8 | 7 | 1 |
| tensorfloat-32 | tf32 | 8 | 10 | 1 |
| single-precision | float32, fp32 | 8 | 23 | 1 |
| double-precision | float64, fp64 | 11 | 52 | 1 |

With a fixed number of digits, a floating-point format may be used to represent values of different orders of magnitude in computing. The sign bit indicates whether a value stored using the floating-point format is positive or negative. The mantissa includes one or more mantissa digits of a value stored using the floating-point format. Therefore, the size, i.e., number of bits, of the mantissa of the floating-point format represents a maximum possible precision of any value stored using the floating-point format. The exponent represents the power of a scaling base used to convert the stored value into a normalized form. Therefore, the size of the exponent of the floating-point format represents a maximum possible range of any value stored using the floating-point format.

Within the example floating-point formats in Table 2, the half-precision floating-point (fp16) format uses 16 bits to store a value, while the single-precision floating-point (fp32) format uses 32 bits to store a value. Thus, fp16 format uses reduced memory space than fp32 format when storing the same number of values.

Converting the values of the parameters of the neural network 102 from the given (initial) format, e.g., a larger range and/or precision format, to a compact format, e.g., a smaller range and/or precision format, therefore, means that fewer bits will be needed to allocate in the computer memory (e.g., in a logical data storage area or physical data storage device) for each parameter when storing the neural network 102. Accordingly, the memory footprint of the neural network 102 is reduced (despite that the total number of parameters of the neural network stays the same).

The compression system 100 performs compression by using the flexible compression techniques discussed below to process a set of parameters 105 of a machine learning model to generate a set of compressed parameters 135 of a compressed version of the machine learning model.

The compression system 100 provides the set of parameters 105 of the machine learning model as input to a range identification engine 110. In cases where the machine learning model is a neural network that includes multiple layers, the set of parameters 105 can be parameters associated with one or more layers of the neural network, e.g., the parameters of the layer 104 of the neural network 102, or a portion of a layer of the neural network, e.g., a subset of the parameters of the layer 104 of the neural network. In other cases where the machine learning model is a non-neural model, the set of parameters 105 can be parameters of any portion of the machine learning model. For example, when configured as a decision tree model, the set of parameters 105 can be parameters associated with one or more decision trees of decision tree model.

The range identification engine 110 is configured to receive the set of parameters 105 as input and to process the trained values of the set of parameters 105 to identify, from among a possible range of trained values of the set of parameters 105, one or more dense ranges 113 for the set of parameters 105. The identification of the dense range(s) is based on the distribution of the trained values of the set of parameters 105.

The range identification engine 114 is configured to identify the one or more dense ranges 113, such that the density of the trained values within the dense ranges 113 meets a minimum density criterion, for example, such that the trained values of at least a threshold number or percentage (e.g., greater than 95%, 98%, or 99%) of the set of parameters 105 collectively fall within the dense ranges 113, more than a certain amount of the set of parameters 105 collectively fall within those ranges, or the like. For example, if in the distribution of trained values in the set of parameters 105, 95% of the trained values occur within just 2% of all possible values in the distribution given the initial format of the trained values, engine 114 can select the range(s) that contain the 95% of the trained values as one or more dense range(s) 113. In some cases, a dense range 113 can include as few as one value. In the cases where multiple dense ranges 113 are identified, they need not be adjacent to each other, e.g., they can be separated by one or more sparse ranges 115.

In some cases, the range identification engine 114 is also configured to identify one or more sparse ranges 115 for the trained values, such that the density of the trained values within the sparse ranges 115 does not meet the minimum density criterion. In other cases, the range identification engine 114 identifies any ranges that are outside of the one or more dense ranges 113 (but within the possible range of parameter values) as the sparse range(s) 115.

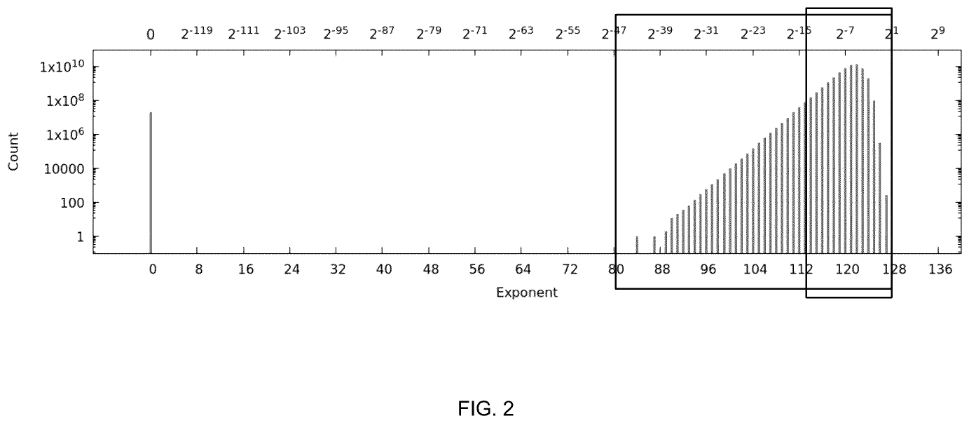

FIG. 2 shows a histogram illustrating an example distribution of values of a set of parameters of a trained machine learning model. In FIG. 2, the X1-axis (bottom) represents exponent values. The exponent is biased upward by 127, so that numbers in the range 2⁻¹²⁷ to 29 are represented using integers from 0 to 136. The X2-axis (on top) represents the actual values in the form of base^{exponent}, where the base is 2. The Y-axis represents the total count of parameters having a given value on a log 10 scale.

As can be seen, the exponents of most of the parameter values are clustered within a certain range of [80, 128] and at zero. In FIG. 2, the exponents in the range [136, 255] are not shown since there are no parameter values the exponents of which fall within this range. Within the [80, 128] range, the exponents of the majority of the parameter values fall within the range of [113, 128], while the exponents of a decreasing number of parameter values spread out in a long tail within the range of [80, 112].

In particular, those parameters values, which have exponents that fall within the range of [80, 112], only make up roughly 0.5% of the total count of parameter values having exponents that fall within the range of [80, 128] (while the parameters values which have exponents that fall within the range of [113, 128] make up roughly 99.5% of the total count). Accordingly, in the example of FIG. 2, the range of [0,0] and the range of [113, 128] may be considered as dense ranges, whereas the range of [1, 112] may be considered as a sparse range.

The range identification engine 114 can determine the one or more dense ranges 113 in any appropriate way. In some cases, the range identification engine 114 can automatically analyze the trained values of the set of parameters 105 and select, as the dense ranges 113, one or more smaller ranges within the entire, possible range of trained values of the set of parameters. Collectively, the density of the trained values within the dense ranges 113 meets a minimum density criterion, e.g., such that the trained values of more than a certain percentage (or amount) of the set of parameters collectively fall within those ranges.

In other cases, the range identification engine 114 can provide the trained values of the set of parameters 105 for display to a user of the system, e.g., in the format of a histogram, and, correspondingly, receive a user input that defines the one or more dense ranges 115.

In either case, the total number of the parameters having trained values that fall within the one or more dense ranges 113 is greater, usually orders of magnitude greater, than the total number of the parameters having trained values that fall outside the one or more dense ranges 113, i.e., fall within the one or more sparse ranges 115. For example, in FIG. 2, only about 0.5% of the parameters have trained values fall outside the dense regions of [0,0] and [113, 128].

The compression system 100 provides the one or more dense ranges 113 to a format identification engine 120. The format identification engine 120 is configured to receive as input the one or more dense ranges 113 and, in some cases, the one or more sparse ranges 115 that have been identified for the set of parameters 105, and to process the input to select a compact format 123 that is optimal for representing the trained values of the parameters within the one or more dense ranges 113.

Any of a variety of candidate formats, including the integer and floating-point formats discussed above and other known formats, can be selected as the compact format 123 for optimal representation of the trained values of the parameters within the one or more dense ranges 113. The compact format 123 may be selected to decrease the data size of the parameter values. A format using a certain number of exponent bits to represent a value may be selected to reduce certain types of numerical errors, such as truncation errors.

In particular, the compact format 123 can be a format that uses fewer number of exponent bits to represent a trained value than the original, given format that was used to represent the trained value, e.g., during the training of the neural network. This is because the one or more dense ranges 113 are generally smaller than the entire, possible range for the trained values of the parameters; the smaller is the range, the fewer exponent bits are required for distinguishably representing each value with the range.

In some cases, the format identification engine 120 can first determine the least number of exponent bits required to uniquely represent each value within the one or more dense ranges 113, and then select a format based on the determined least number of exponent bits. Continuing with the example of FIG. 2, since there are 16 distinct integer values with the dense ranges of [0,0] and [114, 128], a total of 4 exponent bits will be needed (since 2⁴=16). Accordingly, the format identification engine 120 can select an 8-bit container format, e.g., an int8 integer format or another known format that can be represented by an 8-bit container, as the compact format to represent each value within the dense ranges. A multi-bit container refers to a data structure that includes a fixed number of bits; for example an 8-bit container includes 8 bits, a 16-bit container includes 16 bits, and so on.

As an example of an 8-bit container format, int8 integer format allocates 4 bits for the exponent, 3 bits for the mantissa, and a single sign bit. On the other hand, the original, given format that was used to represent the values of the set of parameters could be, e.g., a bfloat16 or tf32 floating-point format, which uses 8 or more bits for the exponent.

In some other cases, the format identification engine 120 can additionally or alternatively determine the least number of mantissa bits required to represent each value within the one or more dense ranges 113. In other words, the selection of the compact format 123 can be based not only on the determined least number of exponent bits, but also on the determined least number of mantissa bits, which represents a maximum possible precision of any value stored using the format. A format using a certain number of mantissa bits to represent a value may be selected to reduce certain types of numerical errors, such as roundoff errors.

For example, the format identification engine 120 can generate and analyze a plot of model performance in the form of a receiver operating characteristic (ROC) AUC curve, which shows the performance, e.g., accuracy, of the model with respect to different mantissa sizes (i.e., different numbers of mantissa bits) that are used to represent the parameter values of the model, and then select a particular mantissa size that corresponds to a desired level of performance. In other examples, the format identification engine 120 can generate and analyze a plot of F1-scores, recall, top-K scores, BLEU scores, and so on to select the particular mantissa size.

In those other cases, the format identification engine 120 can first determine (i) the least number of exponent bits, (ii) the least number of mantissa bits, or both that are required to represent each value within the one or more dense ranges 113, and then select, as the compact format 123, a format based on the determined least number of exponent bits and the determined least number of mantissa bits. For example, the format identification engine 120 can do this by selecting a format that allocates (i) at least as many exponent bits as the determined least number of exponent bits, and at least as many mantissa bits as the determined least number of mantissa bits.

In some cases, the format identification engine 120 can determine the least number of exponent bits and the least number of mantissa bits separately and in any order. For example, the format identification engine 120 determines that 3 exponent bits are required to represent each value within the one or more dense ranges 113, and independently determines that 3 mantissa bits are required to represent each value within the one or more dense ranges 113.

In some other cases, the format identification engine 120 can selecting the format by jointly determining the optimal numbers of exponent bits and mantissa bits. For example, the format identification engine 120 evaluates a ROC AUC curve for various combinations of exponent and mantissa bits, e.g., 2 exponent bits and 4 mantissa bits, 2 exponent bits and 5 mantissa bits, and so on, and then determine which is the optimal format for accuracy.

The compression system 100 provides the compact format 123 to a mapping engine 130. The mapping engine 130 is configured to, for a trained value of a parameter in the set of parameters 105 that falls within the one or more dense ranges 113, map the trained value to a compressed value within a target range and having a target precision level that correspond to the compact format 123 in accordance with a mapping scheme.

In some cases, the target range is the same as the maximum range allowed by the number of exponent bits in the compact format 123. In other cases, the target range is a smaller sub-range of the maximum range allowed by the number of exponent bits in the compact format 123.

Analogously, in some cases, the target precision level is the same as the highest precision level allowed by the number of mantissa bits in the compact format 123. In other cases, the target precision level is lower than the highest precision level allowed by the number of mantissa bits in the compact format 123.

In some cases, the mapping engine 130 can map the trained values of the parameters that fall within the dense range 113 by determining one or more scale factors and applying the scale factor to each trained value. Each scale factor defines how each trained value within a dense range can be mapped to a compressed value within the target range that corresponds to the trained value within the dense range. Calculating the scale factor varies depending on the actual size of the target range. In the cases where multiple dense ranges are identified, a different factor can be calculated for each dense range in order to map trained values from different dense ranges to the common, target range.

Accordingly, the compressed parameters 135 to be provided by the compression system 100 to the inference system 150 include parameters in the set of parameters 105 having trained values that fall within the one or more dense ranges 113. Each such parameter has a compressed value represented in a compact format 123 (which is usually different from its trained value represented in the original, given format).

In some cases, the compression system 100 also provides data that defines the mapping scheme, e.g., data that defines the scale factor(s), to the inference system 150 for de-compression of the compressed parameters 135 by the decompression engine 160 when processing new inputs to generate new outputs.

In some cases, the compression system 100 further provides information about the format itself, e.g., information indicating which multi-bit container format has been chosen as the compact format 123.

The mapping engine 130 is also configured to, for a trained value of a parameter in the set of parameters 105 that fall outside the one or more dense ranges 113, i.e., fall within the one or more sparse ranges 115, set the trained value to zero, or another predetermined value (e.g., a saturated value, namely the largest value allowed by the compact format). Thereby, the trained values of some of the set of parameters 105 that fall within the sparse range(s) are replaced with zeros, or some other predetermined values.

By replacing the trained values of certain parameters with zeros, or some other predetermined values, the computation and storage requirements of the machine learning model can be reduced and, since these parameters make up only a nominal amount of the set of parameters 105, this can be done without incurring a significant accuracy loss when performing inference.

In some implementations, the zeros are not treated separately, and the zeros take up as much space in a memory as other parameters having non-zero values. In other implementations, however, the zeros are not stored in the computer memory, because a zero value does not contribute to the computational result of the operations, e.g., matrix summations or multiplications, of the machine learning model. In these other cases, nor need the zeros be provided by the compression system 100 as part of the data specifying the compressed parameters 135 to the inference system 150.

Omitting the zero-valued parameters may allow for saving memory bandwidth, and reducing the necessary memory size. However, the original indices of those parameter in the set of parameters 105 that have been set a zero value may need to be known during the operations such that the set of parameters 105 can be combined with the proper input values. As such, in some cases, the mapping engine 130 generates metadata indicating the index of each parameter having a trained value that has been set to zero. In these cases, the metadata, i.e., instead of the zeros, is provided by the compression system 100 together with the compressed parameters 135 to the inference system 150.

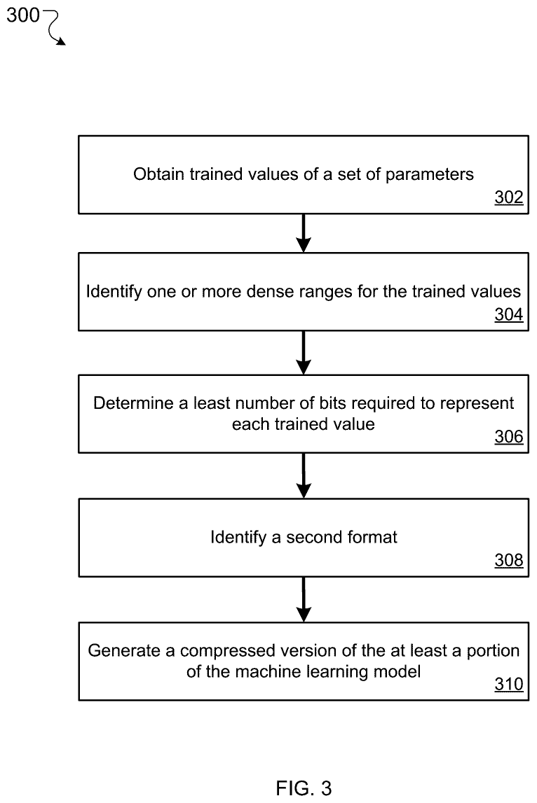

FIG. 3 is a flow diagram of an example process 300 for compressing a machine learning model. For convenience, the process 300 will be described as being performed by a system of one or more computers located in one or more locations. For example, a machine learning model compression system, e.g., the machine learning model compression system 100 of FIG. 1, appropriately programmed, can perform the process 300.

In general, the system can receive a machine learning model and perform one or more iterations of the process 300 to determine a compressed version of the machine learning model. During each iteration, the system compresses a respective portion of the machine learning model.

In some cases, the machine learning model is a neural network. The neural network can be configured to receive any kind of digital data input and to generate any kind of prediction (e.g., generative, classification, or regression) output based on the input. The neural network can be a feed-forward neural network (e.g., an attention neural network, a multi-layer perceptron, or a convolutional neural network), a recurrent neural network (e.g., a long short-term memory network), or any other kind of neural network.

In some other cases, the machine learning model is one of a decision tree model, a random forest model, a gradient boosting model, a linear regression model, a logistical regression model, a support vector machine (SVM) model, and so on.

In either cases, the machine learning model can be trained, that is, the parameter values of the machine learning model have been tuned to improve the performance of the model on its prediction task.

The system obtains trained values of a set of parameters for at least a portion of a machine learning model (step 302). In some cases, the system identifies all the parameters of the machine learning model as parameters to be compressed. In some other cases, the system identifies a proper subset of the parameters of the machine learning model as parameters to be compressed. For example, in cases where the machine learning model is a neural network that includes multiple layers, the set of parameters can be parameters associated with one or more layers of the neural network, or can alternatively be parameters associated with a portion of a layer of the neural network, e.g., a subset of the parameters of a single layer of the neural network.

The trained values of the set of parameters are represented in a first format having a first range, which is the maximum possible range of any value stored using the first format. For example, the first format can be the original, given format that was used to represent the trained values, e.g., during the training of the neural network.

The system identifies one or more dense ranges for the trained values (step 304). The identification is based on the distribution of the trained values of the set of parameters. Each dense range is defined by a respective dense range lower threshold value and a respective dense range upper threshold value, which both fall within the maximum possible range of any value stored using the first format.

For example, the identification process can involve searching through a space of various possible multi-bit container formats. For example, the system first determines that 4 or fewer number of exponent bits are needed, and then determines that 4 or fewer number of mantissa bits are needed. This reduces search space of possible multi-bit container formats. The system then exhaustively evaluates all possible multi-bit container formats within the reduced search space to identify a particular format that results in optimal model performance, e.g., 2 exponent bits and 3 mantissa bits, 2 exponent bits and 4 mantissa bits, 1 exponent bit and 4 mantissa bits, and so on.

In particular, the one or more dense ranges collectively define a range of values for which a density of the trained values within the range meets a minimum density criterion. For example, the minimum density criterion can require that the trained values of at least a certain percentage of the set of parameters collectively fall within the one or more dense ranges. As another example, the minimum density criterion can require that the trained values of at least a certain number of the set of parameters collectively fall within the one or more dense ranges.

In some cases, the required percentage (or, the required number) of the parameters in these examples may be a tunable parameter of the system. For example, it can be specified by a user of the system. As another example, it can be automatically determined by the system based on some given information, e.g., a target compression ratio, a maximum allowed quality loss, or the like.

In some cases, the system also identifies one or more sparse ranges. Like the dense ranges, each dense range is defined by a respective sparse range lower threshold value and a respective sparse range upper threshold value, which both fall within the maximum possible range of any value stored using the first format. Unlike the dense ranges, however, the one or more sparse ranges collectively define a range of values for which a density of the trained values within the range does not meet the minimum density criterion. Thereby, a total number of the trained values within the one or more dense ranges is greater, usually orders of magnitude greater, than a total number of the trained values outside the one or more dense ranges, i.e., within the one or more sparse ranges.

The system determines a least number of exponent bits required to uniquely represent each trained value within the one or more dense ranges (step 306). As mentioned above, the number of the exponents of a floating-point format represents the maximum possible range of any value stored using the floating-point format. Therefore, more exponent bits will generally be required as the sizes of the dense ranges increase.

In some cases, the system additionally determines a least number of mantissa bits required to represent each value within the one or more dense ranges. For example, the determination of the number of the mantissa bits can be based on the varying levels of performance of the model when having its parameter values represented using different numbers of the mantissa bits, e.g., such that a particular number of the mantissa bits that corresponds to a desired level of performance will be selected. Generally, the precision of the floating-point formats, and, therefore, the model performance, increases as more mantissa bits are used.

The system identifies a second format (step 308). The identification is based on the determined least number of exponent bits, and, in some cases, the determined least number of mantissa bits, that are required to represent each trained value within the one or more dense ranges. In particular, the second format a format that uses fewer exponent bits to represent a trained value, and, therefore, has a smaller range, than the first format that was used to represent the trained value.

Any of a variety of candidate multi-bit container formats, including the integer and floating-point formats discussed above and other known formats, can be selected as the second format for optimal representation of the trained values of the parameters within the one or more dense ranges. Specifically, the system can select, from among multiple known formats that correspond respectively to different numbers of exponent bits, a candidate format that allocates at least as many exponent bits as the determined least number of exponent bits as the second format. Analogously, when the number of mantissa bits is also considered, the system can select, as the second format, a candidate format that allocates (i) at least as many exponent bits as the determined least number of exponent bits, and (ii) at least as many mantissa bits as the determined least number of mantissa bits.

For example, the first format may be a bfloat16 floating-point format that allocates 8 bits for exponent and 7 bits for mantissa, while the second format may be an int8 integer format, which corresponds to a format that allocates 4 bits for exponent and 3 bits for mantissa. As another example, the first format may be a fp32 floating-point format that allocates 8 bits for exponent and 23 bits for mantissa, while the second format may be an fp16 floating-point format, which allocates 5 bits for exponent and 10 bits for mantissa.

The system compresses the values of the set of parameters for at least the portion of the machine learning model, thereby generating a compressed version of the portion of the machine learning model (step 310). Compressing the values of the set of parameters includes converting the trained values of the set of parameters within the one or more dense ranges from the first format (a larger range and/or precision format) to compressed values represented by the second format (a smaller range and/or precision format).

In some cases, the system can convert the trained values of the set of parameters from the first format to compressed values represented by the second format by generating a mapping from the trained values that each have the first format to the compressed values that each have the second format, and then converting the trained values in accordance with the mapping. In these cases, the mapping can be defined by a corresponding scale factor for each dense range. The conversion can thus be done by applying the corresponding scale factor to the trained values of the set of parameters within each dense range.

Compressing the values of the set of parameters also includes assigning a zero value, or another predetermined value (e.g., a saturated value), to each of the parameters in the compressed version of the portion of the machine learning model whose trained values were not within the one or more dense ranges. That is, the system sets the parameters having trained values that fall within the one or more sparse ranges to zeros or some other predetermined values. In some cases, instead of storing those zeros or some other predetermined values, the system generates and stores, e.g., as a part of the compressed version of the portion of the machine learning model, metadata indicating the index of each parameter having a trained value that has been set to zero or another predetermined value.

By performing one iteration of the process 300, the system can thus generate a compressed version of the portion of the machine learning model which includes (i) compressed values for a proper subset of the set of parameters that are represented by the second format (ii) metadata indicating the remaining parameters in the set that have been assigned zero values or some other predetermined values.

By repeatedly performing the process 300 for distinct portions of the machine learning model to compresses different sets of parameters of the model, the system can generate a compressed version of the entire machine learning model, e.g., a compressed version of all of the layers included in a neural network.

Moreover, because the distributions of the parameter values for the distinct portions of the model will usually differ from one another, a different compact format could be selected by the system at each iteration of the process 300. As such, the compressed versions of different portions of the model need not use the same compact format to represent the parameter values. For example, the system can generate a compressed version of a neural network with mixed-range and/or mixed-precision, namely the values of the parameters associated with different layers are represented using different formats.

The compressed version of the machine learning model can then be stored for immediate or later use, e.g., in processing an input to generate an output, in a memory of a computing device.

In some implementations, the computing device is or includes a hardware accelerator, and the memory can be any memory portion of the hardware accelerator. Hardware accelerators that are particularly designed can perform specific functions and operations, including operations or computations specified in a neural network, faster and more efficiently when compared to operations run by general-purpose central processing units (CPUs).

Example hardware accelerators can include graphic processing units (GPUs), tensor processing units (TPUs), vector processing units (VPUs), field programmable gate arrays (FPGAs), or application-specific integrated circuits (ASICs). Example memory portions of such hardware accelerators include off-chip dynamic random-access memories (DRAMs) and high-bandwidth memories (HBMs).

Some existing hardware accelerators are configured to perform arithmetic operations associated with vectorized computations for a multi-dimensional data array. For example, some VPUs are each configured to perform arithmetic operations associated with vectorized computations for a multi-dimensional tensor where one of the dimensions is 8, e.g., a 128×8 tensor, a 128×8×32 tensor, or the like.

In these implementations, the system can convert the compressed values represented by the second format into a predefined format compatible with the existing hardware accelerator, and then store into the hardware accelerator the compressed values in the predefined format.

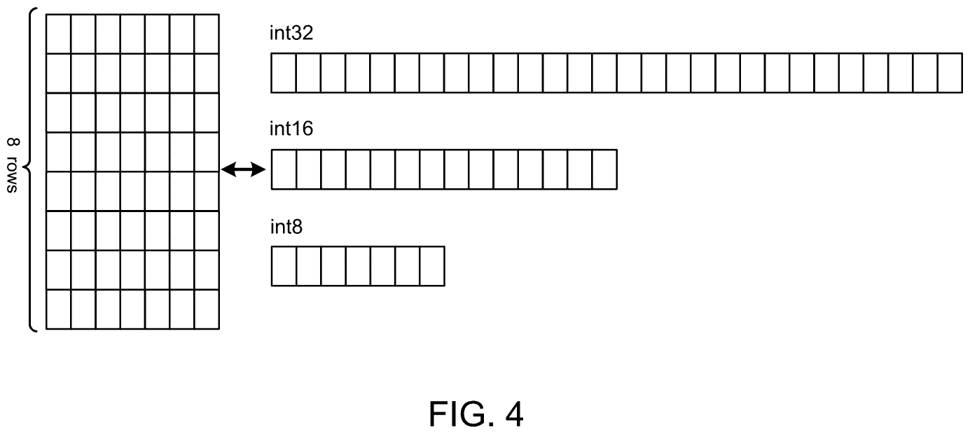

FIG. 4 is an example illustration of storing a compressed machine learning model in a computing device. The computing device in the example of FIG. 4 is a vector processing unit that is configured to perform arithmetic operations associated with vectorized computations for a 128×8×32 tensor.

In some examples, the vector processing unit configured to perform arithmetic operations associated with vectorized computations for values stored in multi-bit container formats, e.g., integer formats. As mentioned above, an integer represented in int8 format takes 8 bits, an integer represented in int16 format takes 16 bits, an integer represented in int32 format takes 32 bits, and so on.

Hence, when the computing device is a vector processing unit, the system can unpack the vector elements of a vector representing the compressed version of the machine learning model, and combine these vector elements into multitude of 8-bit container formats. In some examples, the system can unpack and combine the vector elements into a vector in the dimension of 8 rows by 32 bits, 16 rows by 32 bits, 32 rows by 32 bits, or the like. The system can then convert the compressed values represented by the second format into a predefined multi-bit container format, e.g., an int8, int16, or int32 format, which is compatible with the vector processing unit, and store the compressed values in the predefined format, e.g., in association with a conversion descriptor that specifies the second format.

Operations involved in the conversion can be performed by any of a variety of suitable codec (encoder-decoder) engine, such as one or more microprocessors, digital signal processors (DSPs), application specific integrated circuits (ASICs), field programmable gate arrays (FPGAs), discrete logic, software, hardware, firmware or any combinations thereof.

Such a convert-and-store scheme may result in improved compressibility of a machine learning model, which in turn, increases the storage capacity of the 8-bit containers of the existing vector processing unit. As a result, the same hardware accelerator can now store more parameter values of a machine learning model than previously possible.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computed-implemented method comprising:
obtaining trained values of a set of parameters for at least a portion of a machine learning model, the trained values represented in a first format;
identifying one or more dense ranges for the trained values, the one or more dense ranges collectively defining a range of values for which a density of the trained values within the range meets a minimum density criterion;
determining a least number of bits required to represent each trained value within the one or more dense ranges;
identifying, based at least on the determined least number of bits required to represent each trained value within the one or more dense ranges, a second format having a range that is smaller than a range of the first format; and
generating a compressed version of the at least a portion of the machine learning model by:
(i) converting the trained values of the set of parameters within the one or more dense ranges from the first format to compressed values represented by the second format, and
(ii) assigning predetermined values to each of the parameters in the compressed version of the at least a portion of the machine learning model whose trained values were not within the one or more dense ranges.

2. The method of claim 1, wherein the first format is a floating-point format.

3. The method of claim 1, wherein determining the least number of bits required to uniquely represent each value within the one or more dense ranges comprises:
determining a number of exponent bits required for uniquely representing represent each value within the one or more dense ranges.

4. The method of claim 1, determining the least number of bits required to uniquely represent each value within the one or more dense ranges comprises:
determining a number of mantissa bits required for representing represent each value within the one or more dense ranges.

5. The method of claim 1, wherein identifying the second format having the second level of precision comprises:
selecting, from among multiple candidate formats that correspond respectively to different numbers of bits, a candidate format that corresponds to the determined least number of bits as the second format.

6. The method of claim 1, wherein converting the trained values of the set of parameters comprises:
generating a mapping from the trained values that each have the first format to the compressed values that each have the second format; and
converting the trained values in accordance with the mapping.

7. The method of claim 6, wherein generating the mapping comprises generating a scale factor for each dense range.

8. The method of claim 1, wherein the minimum density criterion requires that at least a particular percentage of the set of parameters are within the one or more dense ranges.

9. The method of claim 1, wherein the neural network is a Transformer neural network, and wherein the first layer is one of an embedding layer, an attention layer, or a feed-forward layer of the Transformer neural network.

10. One or more non-transitory computer-readable storage media storing instructions that when executed by one or more computers cause the one or more computers to perform operations comprising:
obtaining trained values of a set of parameters for at least a portion of a machine learning model, the trained values represented in a first format;
identifying one or more dense ranges for the trained values, the one or more dense ranges collectively defining a range of values for which a density of the trained values within the range meets a minimum density criterion;
determining a least number of bits required to represent each trained value within the one or more dense ranges;
identifying, based at least on the determined least number of bits required to represent each trained value within the one or more dense ranges, a second format having a range that is smaller than a range of the first format; and
generating a compressed version of the at least a portion of the machine learning model by:
(i) converting the trained values of the set of parameters within the one or more dense ranges from the first format to compressed values represented by the second format, and
(ii) assigning predetermined values to each of the parameters in the compressed version of the at least a portion of the machine learning model whose trained values were not within the one or more dense ranges.

11. The computer-readable storage media of claim 10, wherein the neural network is a Transformer neural network, and wherein the first layer is one of an embedding layer, an attention layer, or a feed-forward layer of the Transformer neural network.

12. A system comprising:
one or more computers; and
one or more storage devices storing instructions that, when executed by the one or more computers, cause the one or more computers to perform operations comprising:
obtaining trained values of a set of parameters for at least a portion of a machine learning model, the trained values represented in a first format;
identifying one or more dense ranges for the trained values, the one or more dense ranges collectively defining a range of values for which a density of the trained values within the range meets a minimum density criterion;
determining a least number of bits required to represent each trained value within the one or more dense ranges;
identifying, based at least on the determined least number of bits required to represent each trained value within the one or more dense ranges, a second format having a range that is smaller than a range of the first format; and
generating a compressed version of the at least a portion of the machine learning model by:
(i) converting the trained values of the set of parameters within the one or more dense ranges from the first format to compressed values represented by the second format, and
(ii) assigning predetermined values to each of the parameters in the compressed version of the at least a portion of the machine learning model whose trained values were not within the one or more dense ranges.

13. The system of claim 12, wherein the first format is a floating-point format.

14. The system of claim 12, wherein determining the least number of bits required to uniquely represent each value within the one or more dense ranges comprises:
determining a number of exponent bits required for uniquely representing represent each value within the one or more dense ranges.

15. The system of claim 12, determining the least number of bits required to uniquely represent each value within the one or more dense ranges comprises:
determining a number of mantissa bits required for representing represent each value within the one or more dense ranges.

16. The system of claim 12, wherein identifying the second format having the second level of precision comprises:
selecting, from among multiple candidate formats that correspond respectively to different numbers of bits, a candidate format that corresponds to the determined least number of bits as the second format.

17. The system of claim 12, wherein converting the trained values of the set of parameters comprises:
generating a mapping from the trained values that each have the first format to the compressed values that each have the second format; and
converting the trained values in accordance with the mapping.

18. The system of claim 17, wherein generating the mapping comprises generating a scale factor for each dense range.

19. The system of claim 12, wherein the minimum density criterion requires that at least a particular percentage of the set of parameters are within the one or more dense ranges.

20. The system of claim 12, wherein the neural network is a Transformer neural network, and wherein the first layer is one of an embedding layer, an attention layer, or a feed-forward layer of the Transformer neural network.
